(19) United States
(12) Patent Application Publication
(10) Pub. No.: US 2019/0345851 A1
(43) Pub. Date: Nov. 14, 2019

(54) Side Draft, Slide Valve Aspiration

(71) Applicant: Grace Capital Partners, LLC, Little Rock, AR (US)

(72) Inventor: Gary W. Cotton, Ward, AR (US)

(73) Assignee: Grace Capital Partners, LLC, Little Rock, AR (US)

(21) Appl. No.: 16/393,562

(22) Filed: Apr. 24, 2019

Related U.S. Application Data
(60) Provisional application No. 62/669,449, filed on May 10, 2018.

(51) Int. Cl. F01L 5/04; F01L 3/14; F16K 31/12; F01L 7/02; F01L 7/14; F01L 7/16

(52) U.S. Cl. CPC F01L 5/045; F01L 3/14; F16K 31/12; F01L 2101/00; F01L 7/14; F01L 7/16; F01L 7/02

(57) ABSTRACT

Aspiration and multi-section slide valves (24) for internal combustion engines (11). The slide valves (24) include a central, reduced diameter neck (103) connecting separate cylindrical valve sections (104, 105), which have multiple spaced-apart ring groove arrays seating multiple rings. Slide valves (24) utilize spaced apart, continuously pressurized, annular oil confinement zones (101) that are defined between the slide valve exterior and its sleeve (27) between groups of piston ring arrays. The oil zones are axially spaced along the length of the slide valve and continuously pressured by oil flow passageways (106). During slide valve movement these pressurized oil zones tend to stabilize the slide valve (24), preventing metal-to-metal contact such as that associated with rocking, tipping, chafing or scrubbing. When appropriately displaced, the slide valve neck (103) facilitates transverse fluid flow through the slide valve and its confining sleeve between cylinder gas pathways (139, 141).

### CROSS-REFERENCE TO RELATED APPLICATION

This utility conversion patent application is based upon, and claims priority from a prior pending U. S. Provisional Application entitled “Oiling-Enhanced Sliding Valve Aspiration with Transverse Fluid Passageways,” U.S. Ser. No. 62/669,449, filed May 10, 2018, by inventor Gary W. Cotton.

### BACKGROUND OF THE INVENTION

### I. Field of the Invention

The present invention relates generally to internal combustion engine aspiration systems utilizing slide valves rather than poppet valves. More particularly, the present invention relates to slide valve aspiration systems wherein exhaust and intake gases travel transversely through the valve, around a reduced neck portion, and wherein oil pressure is utilized for valve stabilization and control. Aspiration systems of the slide valve type disclosed herein can be found in USPC Class 123, Subclasses 188.4 and 188.5 and CPC classes F01L 5/00 (20060101); F01L 7/02 (20130101); F01L 7/16 (20130101); F01L 7/14 (20130101); F01L 2101/00 (20130101).

II. Description of the Prior Art

U.S. Pat. No. 8,210,147 issued Jul. 3, 2012, and entitled “Sliding Valve Aspiration System,” discloses an internal combustion engine with separate, tubular and hollow sleeve or slide valves. The valves are reciprocated to open and close intake and exhaust passageways in an engine for improved aspiration. The sliding valves are disposed within sleeves horizontally disposed within a head secured proximate the combustion chamber. The valves may be driven in a path normal to the engine pistons by an independent crankshaft that is rotated through an external pulley driven by the engine crankshaft. Fluid flow occurs through the valve interior and through ports dynamically positioned near the compression cylinder, proximate aligned sleeve and head ports. It is the purpose of the instant invention to improve upon the design set forth in U.S. Pat. No. 8,210,147.

As reported in the latter patent, in a typical four-cycle firing sequence, gases are first inputted and then withdrawn from the combustion chamber of each cylinder interior during reciprocating piston movements caused by the crankshaft. Gas pathways must be opened and closed repetitively during repetitive cycles. During the intake stroke, for example, an air/fuel mixture is suctioned through an open intake passageway into the combustion chamber as the piston is drawn downwardly within the cylinder. The intake passageway is typically opened and closed by some form of reciprocating valve mechanism that is ultimately driven by mechanical interconnection to the crankshaft. The combustion chamber must be sealed during the following compression and power strokes, and the valve mechanisms must be closed to block the ports. During the following exhaust stroke, exhaust ports must be opened to discharge spent gases from the combustion chamber.

Spring-biased poppet valves are the most common form of internal combustion engine valve. In overhead valve systems, poppet valves associated with the intake and exhaust passageways are seated within the cylinder head above the combustion chamber proximate the cylinder and piston. Typical reciprocating poppet valves are spring biased, assuming a normally closed position when not deflected. Poppet valves are typically opened by mechanical deflection from valve train apparatus driven by camshafts. Older overhead-valve designs include rocker arms comprising reciprocating levers driven by push rods in contact with camshaft lobes. When the camshaft lobe deflects a push-rod to raise one end of the rocker arm, the opposite arm end pivots downwardly and opens the valve. When the camshaft rotates further, the rocker arm relaxes and spring pressure closes the valve. With modern overhead-cam designs, camshafts are disposed over the valves above the head, and directly deflect the valves without push rods or rocker arms. Some push directly on the valve stem through cam followers or tappets. Some V-configured engines use twin overhead camshafts (i.e., DOHC), one for each head. Some enhanced DOHC designs use two camshafts in each head, one for the intake valves and one for the exhaust valves. The camshafts are driven by the crankshaft through gears, chains, or belts.

Despite the overwhelming commercial success of poppet-valve designs, there are numerous deficiencies and disadvantages associated with poppet valves. Although poppet valve designs provide manufacturing advantages and cost savings, substantial spring pressure must be repeatedly overcome to properly open the valves. Spring pressure results in considerable drag and friction which increases fuel consumption and limits engine RPM. Poppet valve heads are left within the fluid flow passageway, despite camshaft deflection, and the resulting obstruction in the gas flow pathway promotes inefficiency. For example, back pressure is increased by the valve mass obstructing fluid flow, which contributes to turbulence, often negatively influencing fluid flow. Poppet valves are exposed to high combustion chamber temperatures, particularly during the exhaust stroke, that can promote deformation and wear in combination with the mechanical shocks experienced in operation. Thermal expansion of exhaust valves, for example, can interfere with proper valve seating and subsequent sealing, which can decrease combustion performance.

Sliding valves of many configurations are known in the art. Typical slide valves may be hollow and tubular, or planar, or cylindrical. They are reciprocated within a tubular valve seat region proximate the combustion chamber to alternately open and then close the intake and exhaust passageways. Like rotary valves, sliding valve designs have hitherto been difficult to seal effectively, with predictable negative results.

U.S. Pat. No. 2,080,126 issued May 11, 1937 to Gibson shows a sliding valve arrangement involving a tubular valve driven by a secondary crankshaft. Its reciprocating axis is parallel to the axis of piston deflection. Ports arranged at the side of the piston are alternately opened and closed by piston movements, and gases are conducted through and around portions of the piston exterior.

A similar arrangement is seen in U.S. Pat. No. 1,995,307 issued Mar. 26, 1935, and U.S. Pat. No. 2,201,292, issued May 21, 1940, both to Hickey. The latter patents show designs that aspirate a single working cylinder with a pair of tubular, reciprocating valves that are mounted on either side of the piston and driven by secondary crankshafts. The aspirating valves are forcibly reciprocated between port blocking and port aligning positions. The valves are aligned at an angle slightly off of parallel with the axis of the cylinder.

Other examples of engines with tubular, reciprocating slide valves are provided by U.S. Pat. Nos. 1,069,794; 1,142,949; 1,777,792; 1,794,256; 1,855,634; 1,856,348; 1,890,976; 1,905,140; 1,942,648; 2,160,000; and 2,164,522 that are largely cumulative.

U.S. Pat. No. 2,302,442 issued Nov. 17, 1942 shows a tubular, reciprocating sliding valve disposed atop a piston head. The valve slides in an axis generally perpendicular to the axis of the lower drive piston.

U.S. Pat. No. 5,694,890 issued to Yazdi on Dec. 9, 1997 and entitled “Internal Combustion Engine With Sliding Valves” discloses an internal combustion engine aspirated by slidable valves. Tapered, horizontally disposed valve seats are defined near inlet and exhaust ports at the top of the combustion chambers. The slidable valves are tapered to conform to the valve seats. Valve movement is caused by a crankshaft driving a rocker arm that is oriented substantially orthogonal to the rod, whereby crankshaft rotation is translated into horizontal, sliding movements of the planar valves, which reciprocate in a direction normal or transverse to the axis of the piston.

U.S. Pat. No. 7,263,963 issued to Price on Sep. 4, 2007 and entitled “Valve Apparatus For An Internal Combustion Engine” discloses a cylinder head with a cam-driven valve slidably disposed within a valve pocket. The valve, which is displaceable along its longitudinal axis, has a tapered portion defining multiple fluid flow passageways. The valve is displaced by cam rotation between a configurations passing gases through the passageways and a configuration wherein the valve flow passageways are closed.

The prior art also includes three previously issued U. S. utility patents owned by the same assignee as in this case, namely Grace Capital Partners, LLC. These patents include U.S. Pat. No. 8,210,147 issued Jul. 3, 2012, and entitled “Sliding valve aspiration system;” U.S. Pat. No. 8,459,227 issued Jun. 11, 2013 and entitled “Sliding valve aspiration;” and, U.S. Pat. No. 8,776,756 issued Jul. 15, 2014 and entitled “Sliding valve aspiration.” In all of these exhaust and intake gases turn ninety-degrees, traveling generally longitudinally through the valve, whereas in this case travel is straight through.

### SUMMARY OF THE INVENTION

This invention provides an enhanced sliding valve arrangement for internal combustion motor aspiration systems of the general type disclosed in U.S. Pat. Nos. 8,210,147, 8,459,227, and 8,776,756.

In the present design, the exhaust and intake gas pathways are transverse relative to the valve. In other words, exhaust or input gases travel through the slide valve via a transverse path, rather than traveling longitudinally through the slide valve as in previous designs. In other words, gas travel through the instant slide valves is in a direction perpendicular to the longitudinal axis of the slide valve.

The preferred valve has a reduced diameter neck in its middle that allows gases to move transversely through the valve when appropriately positioned. Each slide valve can be driven or displaced by conventional mechanical means, including mechanical actuators, connecting rods, lifters, push-rods, camshafts, pneumatic or hydraulic actuators, or by conventional electromagnetic systems. Preferably each slide valve is disposed within a tubular sleeve, which has transverse ports defined in its approximate middle that pass gases transversely, when the sleeve is positioned with its neck proximate the sleeve ports.

A plurality (i.e., preferably five) sets of spaced-apart ring arrays are provided on the valve body. Preferably, each array may comprise one or more closely spaced-apart rings that adjoin one another. In operation, separate, elongated, annular oiling zones are defined between groups of ring arrays. These annular confinement oiling zones are defined between adjacent ring arrays and the body of the slide valve, and pressured oil is confined within the annular volume. The sleeve and the slide valve therewithin are positioned proximate a power piston, within an appropriate passageway defined, for example, within the engine head. These oiling zones are pressured by communicating, pressured oiling ports. Oil is confined under pressure within these oiling zones during the full reciprocating travel of the slide valves. By so lubricating the moving slide valve under pressure, friction is reduced. Moreover, confined oil pressure balances the slide valve in the sleeve, so there is virtually no rubbing, chafing or valve scrubbing on the bore wall. When the combustion pressure hits the slide valve, it doesn't move the valve because the constrained oil pressure tends to balance the valve in the center of the cylinder bore.

Thus a basic object of my invention is to provide a highly efficient, sliding valve aspiration system for internal combustion engines, particularly four-cycle designs, including both gasoline and diesel fuel powered engines.

A fundamental object is to provide a slide valve of the character described through which gases move transversely, rather than longitudinally. It is a feature of the invention that gas travels through the slide valve in a direction that is substantially perpendicular to the longitudinal axis of the slide valve.

Another basic object is to improve the functioning and efficiency of slide valve aspiration systems used with internal combustion engines.

A related object is to provide a valve system of the character described wherein the valve structure does not enter the combustion chambers.

Another object is to provide a slide valve of the character described through which exhaust or intake gases can flow transversely without turning.

Yet another important object is to provide a slide valve of the character described that may employ continuously pressured oil zones or pockets to minimize friction and wear.

Another important object is to provide an improved slide valve of the character described that can be displaced with magnetic actuators.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a fragmentary, sectional view of a cylinder in a typical internal combustion engine constructed in accordance with the best mode of the invention known at this time showing the new slide valve aspiration design;

FIG. 2 is an enlarged, fragmentary, sectional view derived from circled region 2 of FIG. 1, showing the slide valve in a blocking position;

FIG. 3 is a view similar to FIG. 2, bit showing the slide valve in a moved position allowing transverse gas flow;

FIG. 4 is an enlarged, side elevational view of a preferred slide valve, with the rings omitted for clarity;

FIG. 5 is an end view of the preferred slide valve; FIG. 6 is an enlarged, fragmentary sectional view derived generally from circled region 6 of FIG. 3;

FIG. 7 is a view similar to FIG. 6 that is derived from circled region 7 of FIG. 2, showing slide valve movement;

FIG. 8 is an isometric view of a preferred sleeve; and,

FIG. 9 is a fragmentary isometric view of a preferred sleeve.

### DETAILED DESCRIPTION OF THE PREFERRED EMBODIMENTS

This application incorporates structure and teachings previously described in the following U. S. Patents, which are hereby incorporated by reference as if fully set forth herein: U.S. Pat. No. 8,210,147 issued Jul. 3, 2012, and entitled “Sliding valve aspiration system;” U.S. Pat. No. 8,459,227 issued Jun. 11, 2013 and entitled “Sliding valve aspiration;” and, U.S. Pat. No. 8,776,756 issued Jul. 15, 2014 and entitled “Sliding valve aspiration.”

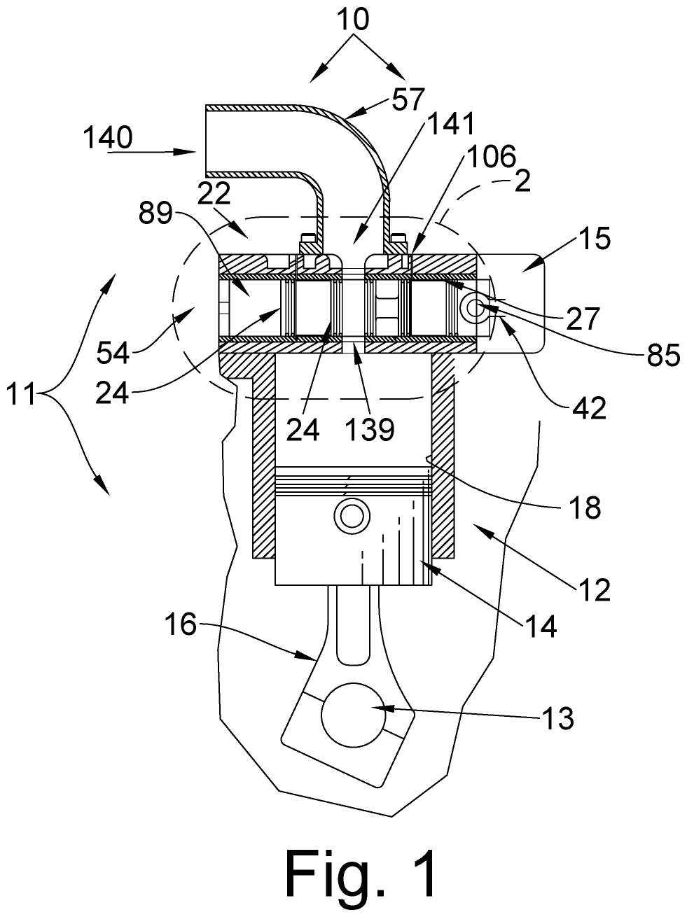

With initial reference directed now to FIG. 1 of the appended drawings, the aspiration system constructed in accordance with the best mode of the invention generally is generally designated by the reference numeral 10. It should be understood that embodiments of the aspiration system 10 as herein described are suitable for use with engines equipped one or multiple cylinders, arrayed in the popular V-configuration or other configurations. The invention is well adapted for use with gasoline, diesel, alcohol, propane or butane and other hydrocarbon fuels.

Those skilled in the art will recognize that a typical engine 11 has a rigid block 12 (FIG. 1) housing a primary crankshaft 13 of conventional construction that drives a reciprocating power piston 14 with a conventional connecting rod 16. The basic engine design illustrated is based upon a conventional Honda thirteen-horsepower motor described in the above cited patents, which is modified as hereinafter described. The engine configuration as illustrated can be varied considerably according to recognized standards known to those with skill in the art.

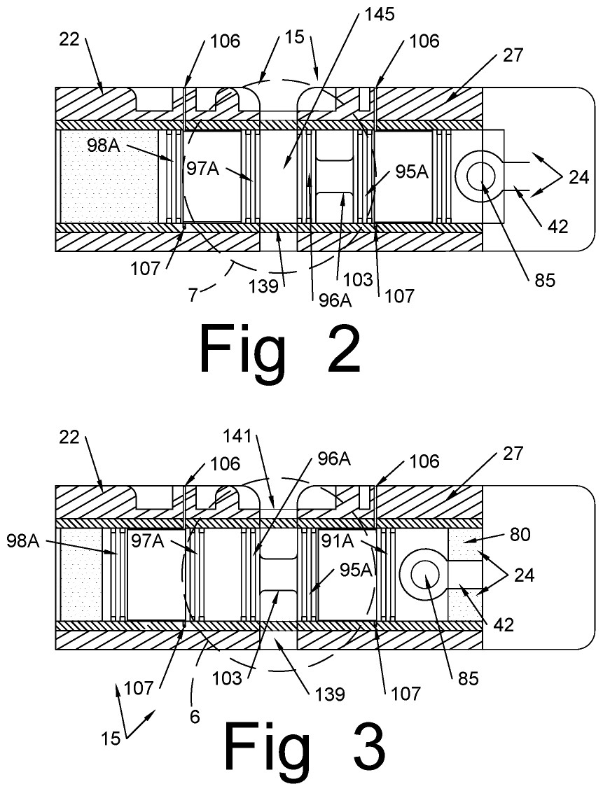

The power piston 14 reciprocates within a cylinder 18 associated with the air-cooled engine 11. The basic construction of piston 14 is substantially conventional and is not critical to practice of the invention. The instant sliding valve system 15 (i.e., FIGS. 2, 3) is disposed within a head, that is generally indicated by the reference numeral 22 (FIG. 1), that mounts conventionally above the piston 14 and cylinder 18 described previously. Piston 14 conventionally reciprocates upwardly and downwardly (i.e., as viewed in FIG. 1) in a direction substantially perpendicular to head 22 by crankshaft 13 and connecting rod 16 in response to firing from a conventional spark plug (not shown). For purposes of this invention, the term “head” shall generally designate that region of an internal combustion engine enclosing the combustion chambers, proximate the pistons. Such a head may be a conventional, separate part bolted atop the engine, or in some cases the “head” may be integral with the engine block in a single casting that is thereafter appropriately machined.

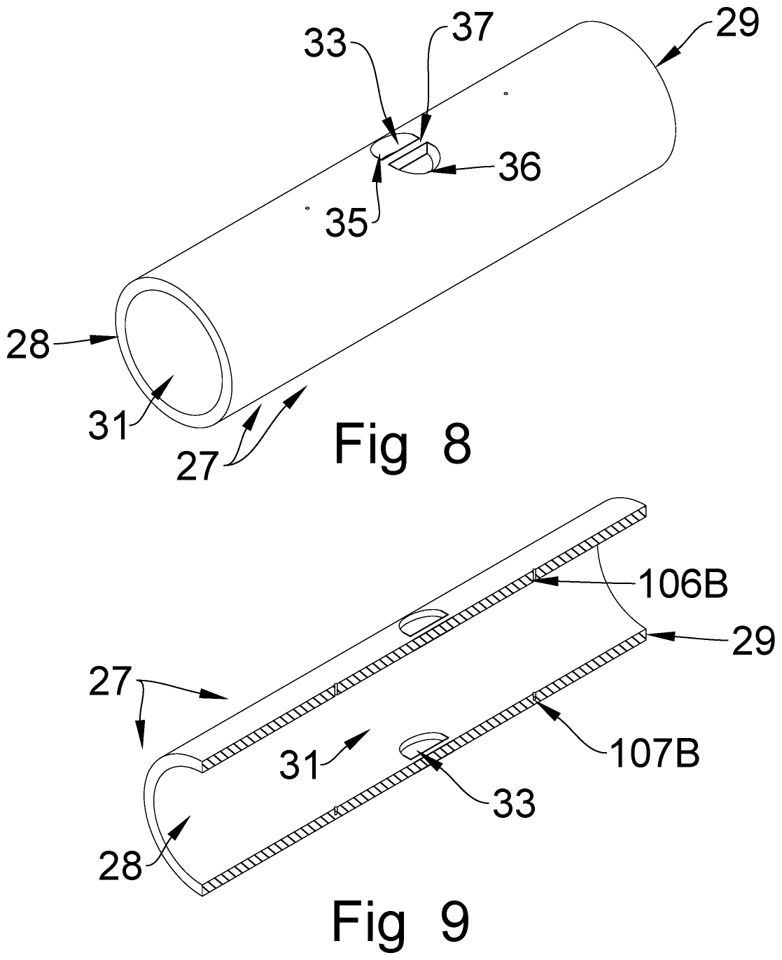

With joint reference directed now to FIGS. 1-4, head 22 includes appropriate internal cylindrical tunnel 54 (FIG. 1) can receive preferred tubular, sleeves 27 (FIGS. 8, 9) that house tubular, slide valves such as slide valve 24 for aspiration. These slide valves reciprocate similarly to movements described in detail in the previously cited Cotton patent references. However, with the present slide valve design, gases are ported transversely through the slide valves instead of longitudinally.

In operation there preferably will be at least one intake slide valve, and at least exhaust slide valve 24 (FIGS. 1, 2) for each engine cylinder. Preferably the slide valves are made from heat resistant alloys such as titanium. It is preferred that the exhaust sleeve 27 be made of Steelite-brand or Nickalloy-brand heat resistant titanium steel alloy. Several alloys of titanium and/or titanium steel are available. Ordinary steel compositions however, result in heat damage and premature wear and failure. It is also preferred that the slide valve 24, and all others, are coaxially mounted in appropriately ported tubular sleeves 27 that fit into the cylinder head 22 within tunnel 54 and line up and register with the appropriate ports. While sleeveless sliding valve designs are functional, sleeves are much preferred. It is also preferred that the sleeves be coated by treating them with Nickel-boron. A manifold 57 exhausts gas during the exhaust stroke.

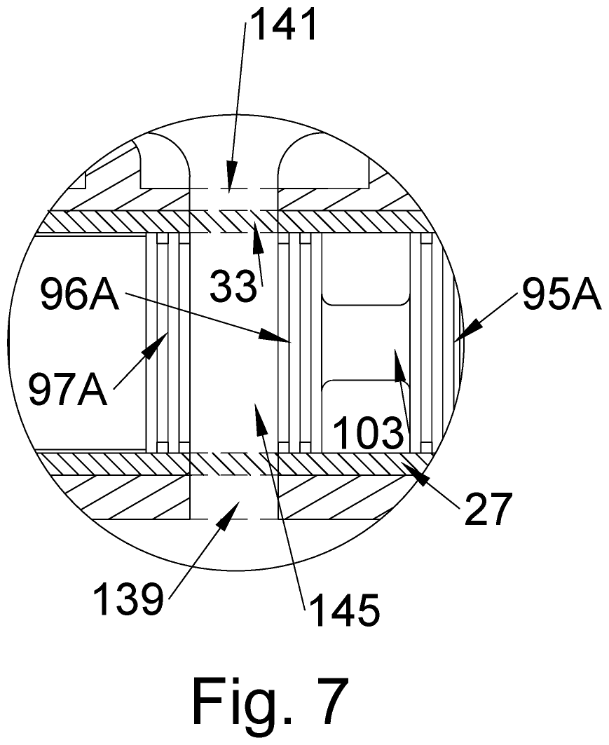

Slide valve 24 slidably reciprocates within sleeve 27 (FIGS. 1, 2) concentrically disposed within tunnel 54 that is predefined in the engine or intake manifold. Sleeves 27 require oiling ports aligned with head ports described in the referenced Cotton patents. Sleeve 27 (i.e., FIGS. 8, 9) is elongated and tubular, and comprises a pair of spaced apart, open ends 28 and 29 bordering an elongated, hollow passageway 31 in which the slide valve 24 reciprocates. Note that there are gas ports 33 defined in the preferred sleeve body (FIGS. 8, 9) for transversely conducting gases through the sleeve, when the slide valve neck is positioned adjacent ports 33 (i.e., FIG. 6). Preferably ports 33 comprise a pair of spaced apart halves 35 and 36, each resembling half of an oval. The generally oval-shaped port configuration is the best known at this time; port edges should be chamfered or otherwise polished for minimal turbulence. Bridge 37 between port halves 35 and 36 maintains the slide valve rings in position as they slide by ports 33. Thus, noting FIGS. 2 and 3, when the sleeves are properly positioned, in the exhaust stroke condition, the gas exhaust pathway 139 from the cylinder will be aligned with sleeve ports 33, and when slide valve neck 103 is positioned as in FIG. 3, gas can flow through pathway 139 and sleeve ports 33, around slide valve neck 103, through output pathway 141 out through manifold 57. In an intake stroke, and air-fuel gas mixture will be sucked into the slide valve via pathway 141, through the sleeve ports 33, and into the cylinder via pathway 139. Thus, depending upon the position of the slide valve 24, fluid flow from or to the cylinder will be enabled through sleeve ports 33 and pathways 139, 141. In FIGS. 2 and 7 the slide valve blocks the ports 33 with its solid cylindrical portion 145 positioned as in FIG. 7. Sealing is accomplished by the rings arrays 97A and 96A, which, comparing FIGS. 6 and 7, have been moved to the right. Noting FIGS. 3 and 6, however, the slide valve, specifically the reduced diameter, slide valve neck portion 103, allows gas flow between pathways 139 and 141.

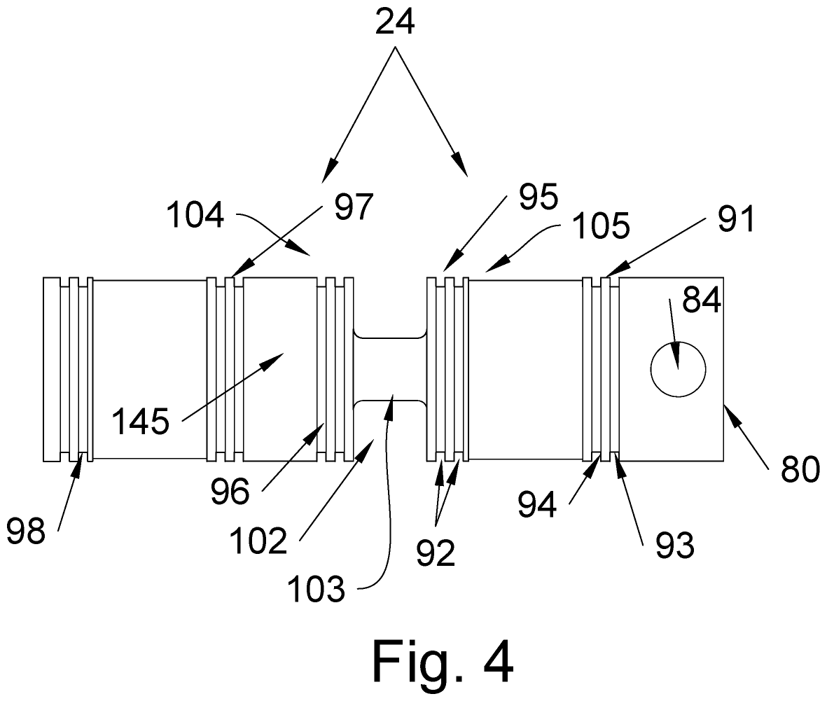

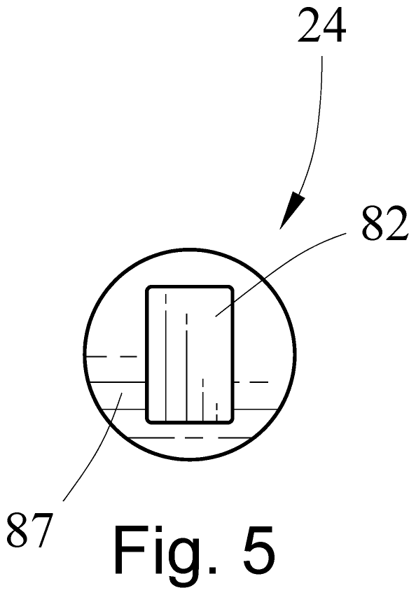

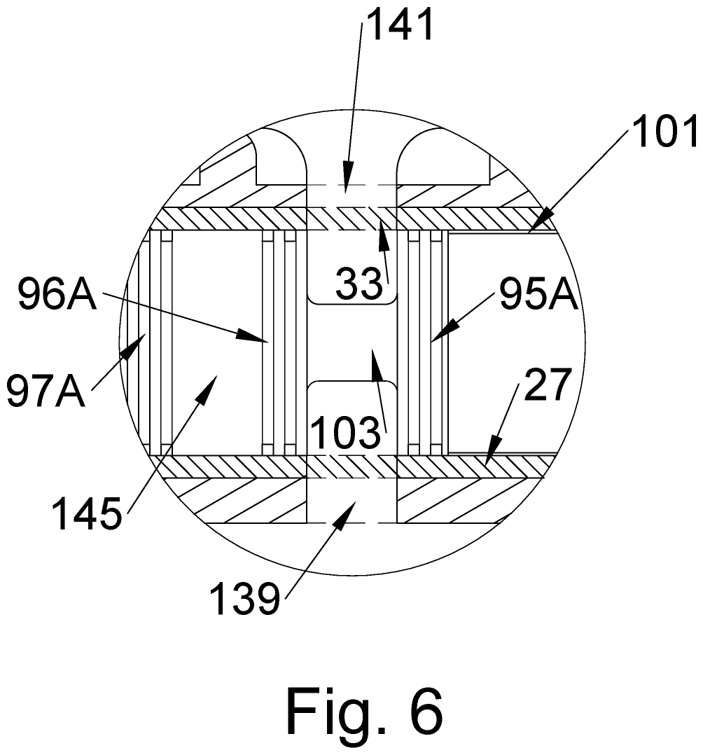

With emphasis directed to FIGS. 2-4, slide valve 24 is elongated, substantially tubular, and multi-sectioned, with an integral, reduced diameter neck 103 connecting the cylindrical slide valve sections 104 and 105 (i.e., FIG. 4). Slide valve neck 103 is concentrically disposed within a reduced diameter, open section of the slide valve 24. An open connecting rod end section 80 (i.e., FIG. 3) enables mechanical connection of the slide valve 24 to a mechanical actuator 42 (FIGS. 1 and 2) that is journaled by a wrist pin 85 retained within end space 82 (FIG. 5) proximate internal closed wall 87 (FIG. 5) between orifices 84 (FIGS. 2, 3). Each slide valve may be reciprocated by a variety of means. For example, mechanical actuators or linkages, connecting rods, lifters, push-rods, camshafts, pneumatic or hydraulic actuators, or electromagnetic systems can be used for periodically reciprocating the slide valve within its sleeve.

In the best mode slide valve 24 has a plurality of spaced apart ring groove arrays that support arrays of rings. Each ring groove array seats a plurality of rings. In the best mode there are five ring groove arrays, each of which supports a ring groove array seating multiple rings. For example, a first ring groove array 91 (i.e., FIG. 4) disposed on section 105 preferably has a pair of concentric and parallel, spaced-apart ring grooves 93 and 94. These support ring array 91A (FIG. 3). The second ring groove array 95 (FIG. 4) comprises similar spaced-apart, concentric ring grooves 92 (FIG. 4) that support and seat ring array 95A (FIG. 3). A third ring groove array 96 (FIG. 4) is spaced apart on slide valve section 104 proximate slide valve neck 103, and it supports ring array 96A (FIG. 3). A fourth ring groove array 97 (FIG. 4) similarly provides for a ring array 97A (FIG. 3). The fifth ring groove array 98 near the valve open end (FIG. 4) seats another similar ring array 98A. With high power and high temperature cylinders each sleeve ring array may comprise multiple ring grooves and rings. Each ring is preferably made of heat treated and heat resistant nickel alloy steel. Preferably the compressively touching, and abutting ring ends are preferably stepped for maximum compression as described in the previously cited Cotton patents.

In preferred embodiments one or more confining, annular oiling zones 101 (FIG. 6) are formed between the external, radial periphery of the slide valve 24 and the inner surface confines of sleeve 27, between spaced-apart pairs of ring arrays. Oil pressure port inlets 106 (i.e., FIGS. 1, 3) pass through the head entering tunnel 54 and align with and pass through the sleeve 27 via its oil ports 106B (FIG. 9) into the annular oiling zone 101 (i.e., FIG. 6). At the bottom of an oiling zone 101 (FIG. 3) there is an oil pressure return galley 107 that lines up with sleeve oil port 107B (FIG. 9). Other annular oil confinement zones may be defined generally between various ring arrays. For example, an oil confinement zone exists between ring arrays 97A and 98A (FIG. 3). These annular confinement oiling zones are defined between adjacent ring arrays and the body of the slide valve within the sleeve, and help stabilize the valve by confining pressurized oil about the eternal periphery of the slide valve.

As the slide valve 24 reciprocates back and forth, oil input ports 106 will always supply oil pressure to the peripheral oiling zones 101. Relief is provided by oil return galleys 107 (FIG. 3) that align with sleeve oil galley 107B (FIG. 9). Similar oiling zones between other ring arrays can be similarly pressured during operation.

FIG. 7 shows the slide valve 24 moved or displaced to the left from the position of FIG. 6. Gas cannot flow between pathways 139 and 141 as the cylindrical, slide valve blocking portion 145 blocks gas passage. In FIG. 6, however, blocking portion 145 has shifted to the left, and the reduced diameter sleeve neck 103 now permits fluid flow communication between pathways 139, 141. During operating, this continuous oil pressure within oil confinement zones 101 helps to stabilize the slide valve, preventing unwanted metal-to-metal contact. Thus valve wear caused by rocking, tipping, chafing or scrubbing is minimized. Referring to FIGS. 1 and 3, the slide valve neck 103 is reduced in diameter. Therefore when such a slide valve is disposed in the intake position, or the exhaust gas output position, as generally seen in FIG. 1, gases can travel transversely relative to the slide valve. Gases can be forced out of the lower combustion chamber through gas pathways 139, 141 (FIG. 6) around slide valve neck 103 and exiting the exhaust manifold 57 through passageway 140 (FIG. 1).

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. A slide valve aspiration system for an internal combustion engine comprising at least one cylinder, the cylinder bordering gas inlet and gas outlet pathways, the slide valve aspiration system comprising:
a slide valve adapted to be reciprocated between a gas conducting position and a spaced-apart gas blocking position within a cylindrical tunnel having transverse gas ports, the slide valve comprising at least a pair of spaced-apart, elongated, rigid, cylindrical sections connected by a reduced diameter neck, said slide valve adapted to be connected to a reciprocation actuator for reciprocating the slide valve;
each cylindrical section provided with a plurality of ring arrays, each ring array comprising at least one ring;
at least one annular oil confinement zone defined between at least one cylindrical valve section and the tunnel in which the valve is disposed between adjacent ring arrays;
an oil inlet communicating with said oil confinement zone;
wherein at least one slide valve section is adapted to periodically block said gas ports; and,
wherein said slide valve neck enables gas flow through said transverse gas ports and said gas inlet and gas outlet pathways.

2. The slide valve aspiration system as defined in claim 1, wherein the slide valve is disposed within a tubular sleeve disposed within said tunnel, and wherein said at least one annular oil confinement zone is defined between at least one cylindrical valve section and said sleeve between adjacent ring arrays.

3. The slide valve aspiration system as defined in claim 2 wherein said sleeve has a pair of spaced apart side ports enabling transverse gas flow through said sleeve when the slide valve neck is positioned proximate said sleeve side ports.

4. A slide valve for an internal combustion engine that has at least one cylinder, the cylinder bordering gas inlet and gas outlet pathways, the slide valve adapted to be reciprocated between a gas conducting position and a spaced-apart gas blocking position within a cylindrical passageway having transverse gas ports, the slide valve comprising:
at least a pair of spaced-apart, elongated, rigid, cylindrical sections connected by a reduced diameter neck, at least one of said sections adapted to be connected with a reciprocation actuator for moving the slide valve;
each cylindrical section provided with a plurality of ring arrays, each ring array comprising at least one ring;
wherein at least one sleeve section is adapted to periodically block said gas ports; and,
wherein said sleeve neck facilitates gas flow through said transverse gas ports and said gas inlet and gas outlet pathways.

5. The slide valve as defined in claim 4 wherein the slide valve forms at least one annular oil confinement zone between at least one cylindrical valve section and the tunnel in which the valve is disposed between adjacent ring arrays.

6. The slide valve as defined in claim 4 wherein spaced-apart ring arrays with rings are disposed proximate each end of said neck.

7. The slide valve aspiration system as defined in claim 4, wherein the slide valve is adapted to be disposed within a tubular sleeve disposed within said tunnel, and wherein said at least one annular oil confinement zone is defined between the exterior of at least one cylindrical valve section and said sleeve interior between adjacent ring arrays.

8. The slide valve aspiration system as defined in claim 7 wherein said sleeve has a pair of spaced apart side ports, and said sleeve ports are aligned with the cylindrical tunnel transverse gas ports to enable transverse gas flow when the slide valve neck is positioned proximate said sleeve ports.

9. The slide valve as defined in claim 8 wherein the slide valve forms at least one annular oil confinement zone between at least one cylindrical valve section and the sleeve in which the valve is disposed between adjacent ring arrays.

10. The slide valve as defined in claim 9 wherein spaced-apart ring arrays with rings are disposed proximate each end of said neck.

11. An internal combustion engine comprising:
at least one cylinder;
at least one power piston that reciprocates within said at least one cylinder;
at least one gas pathway allowing gases into or out of said cylinder;
at least one internal cylindrical tunnel disposed proximate said cylinder;
at least one gas pathway transversely extending through said tunnel communicating with said cylinder;
a slide valve that reciprocates within said tunnel, the slide valve comprising a pair of cylindrical sections concentric with said tunnel and at least one reduced diameter neck portion disposed between a pair of adjacent slide valve body sections that allows gases to move transversely through the slide valve; and,
means for reciprocating the slide valve.

12. The engine as defined in claim 11 wherein each slide valve is coaxially, slidably disposed within a tubular sleeve, and each sleeve is coaxially disposed within said internal cylindrical tunnel, each sleeve comprising ports adapted to be aligned with said gas pathway and said slide valve neck for conducting gases transversely through the slide valve.

13. The engine as defined in claim 12 wherein spaced-apart ring arrays with rings are provided on the valve body cylindrical sections with at least one ring array disposed proximate each end of said neck.

14. The engine as defined in claim 12 wherein at least one elongated, annular, confined oiling zone is defined upon a cylindrical slide valve body section between groups of spaced apart ring arrays.

15. The engine as defined in claim 14 further comprising at least one inlet oil port continuously communicating with and admitting oil into said at least one oil confinement zone as the slide valve moves and at least one oil outlet port continuously communicating with and draining oil from said at least oil confinement zone.

16. The engine as defined in claim 14 wherein spaced-apart ring arrays with rings are disposed proximate each end of said slide valve neck.
